(19) United States
(12) Patent Application Publication
(10) Pub. No.: US 2024/0167722 A1
(43) Pub. Date: May 23, 2024

(54) ASSEMBLY FOR POSITIONING OF REGULATION MEMBRANE, AIR DUCT MEMBER AND AIR DUCT

(71) Applicant: Prihoda s.r.o., Hlinsko (CZ)

(72) Inventor: Zdenek Prihoda, Hlinsko (CZ)

(21) Appl. No.: 18/279,784

(22) PCT Filed: Feb. 24, 2022
(86) PCT No.: PCT/CZ2022/050021

§ 371 Date: Aug. 31, 2023

(30) Foreign Application Priority Data
Mar. 1, 2021 (CZ) PV 2021-95

(51) Int. Cl. F24F 13/14

(52) U.S. Cl. CPC F24F 13/1426; F24F 2013/1493

(57) ABSTRACT

Assembly for positioning of a regulation membrane (1) in an air duct, the assembly comprising: a threaded rod (8), a transferrable holder adapted for attaching the regulation membrane (1) and having a through opening provided with an internal thread, said holder being screwed on the threaded rod (8) and being movable along the longitudinal axis of the threaded rod (8) by rotating the threaded rod (8) in the transferrable holder, and at least one element for delimiting the movement of the transferrable holder along a single plane.

### CROSS REFERENCES

This application is a U.S. National Stage application of PCT Application No. PCT/CZ22/50021, filed Feb. 24, 2022, which claims priority to Czech Application No. CZ 2021-95, filed Mar. 1, 2021, which applications are incorporated herein in their entirety by reference.

### FIELD OF INVENTION

The invention relates to an assembly for positioning a regulation membrane within an air duct, to a connecting member with such assembly, and to an air duct containing the assembly.

### BACKGROUND ART

Air ducts for distribution of air known in the art, which are made of woven or non-woven textile, also called textile outlet, are made of a material sewn to have a closed shape of various cross-sections (duct members). The wall of the duct may be perforated, or provided with through openings, the air being distributed through the perforation/openings. A proper distribution of air is one of the most important functions of an air piping.

In some cases, it is required to have a choice, whether the distributed air will flow downwards or upwards (towards the ceiling), without having to reposition the air duct. To this end, a regulation membrane can be inserted into the air duct, the membrane being made of a light impermeable textile and being sewn into the duct along a plane extending through the longitudinal axis of the duct, the membrane thus covering a first or a second half of the internal wall of the duct as desired. The front part of the regulation membrane is attached to a shutter controlled by a servomotor. It is thus possible to choose between two positions, one of them being generally used for cooling and the other for heating. In the case of heating, the regulation membrane covers the upper internal wall of the horizontally arranged duct, the air exiting downwards through a series of openings. In the case of cooling, the regulation membrane covers the lower half, the air exiting only upwards through the textile or through a microperforation.

The tilting of the regulation membrane is carried out by rotating of a wire shutter having a half-annular shape, as the regulation membrane is attached by one of its ends to the wire shutter, which—when arranged in its end positions—extends adjacent the internal circumference of the duct's cross-section.

When the tilting is performed during operation, an extreme strain is exerted on the regulation membrane, which ruffles in the airflow. The shutter itself and its pivotable housing are also subjected to considerable stress when tensile stress is exerted on the shutter while it is moving from one position to the other, the tensile stress being caused by the airflow interacting with the regulation membrane being tilted.

The object of the invention is to prolong the service life of the regulation membranes and of the tilting mechanism and to provide such a mechanism which would enable fast and safe and long-term reliable positioning of the regulation membrane in the air duct.

### SUMMARY OF THE INVENTION

The above specified disadvantages of prior art are eliminated by means of an assembly for positioning of a regulation membrane in an air duct, the assembly comprising:
a threaded rod,
a transferrable holder adapted for attaching the regulation membrane and having a through opening provided with an internal thread, said holder being screwed on the threaded rod and being movable along the longitudinal axis of the threaded rod by rotating the threaded rod in the transferrable holder, and
at least one element for delimiting the movement of the transferrable holder along a single plane.

The element for delimiting the movement of the holder may be a bar, a guide rail or another threaded rod.

Preferably, the assembly further comprises a frame, to which the threaded rod is attached.

Preferably, the frame comprises a pair of mutually opposite supporting bars, wherein preferably each of the supporting bars (72, 73) is provided with a bearing (74, 75) for rotationally attaching the threaded rod (8) to the supporting bars (72, 73).

It is advantageous, when the frame comprises a pair of mutually opposite and in parallel arranged side bars for guiding the movement of the transfer bar in a plane along the longitudinal axis of the threaded rod and/or for preventing any rotation of the transfer bar about the longitudinal axis of the threaded rod.

In case no side bars are present, the supporting bars may be e.g.:
mutually connected by means of a rod/rail arranged e.g. substantially adjacent/in parallel with the threaded rod, and/or
attached to a metal duct, and/or
attached to a supporting structure of a duct, and/or
mutually connected by means of a pair of cross bars, which are mutually connected at the point of mutual crossing.

Preferably, the assembly further comprises a motor interconnected with the threaded rod for driving the rotational movement about its longitudinal axis, and/or the threaded rod has a pitch of 4 to 12 millimeters (mm), preferably 6 to 10 mm.

The motor, preferably a servomotor, may be supplied by DC, and thus there is preferably a convertor provided for the motor.

The assembly is preferably provided with end limit switches, which are connected to a control unit of the motor and which stop the motor, when the required end position of the holder is reached.

Advantageously, especially when the air duct has a large diameter, the assembly is provided with at least two threaded rods, which are arranged in parallel, wherein the holder is screwed on both of them, e.g. a carrier is screwed on each of the threaded rod and a common transfer rod is attached to both carriers, the transfer rod being transferable along the threaded rods by rotation of the threaded rods in the carriers.

The disadvantages of prior art solutions are also eliminated by an air duct member, inside which the above assembly is arranged, wherein the threaded rod is arranged so that its longitudinal axis lies in a plane perpendicular to the longitudinal axis of the interconnecting duct member.

The disadvantages of prior art solutions are also eliminated by an air duct, inside which the above assembly is arranged, said air duct further comprising a distribution duct in which a regulation membrane is arranged, wherein one end of the regulation membrane is fixed to the transferrable holder for moving the regulation membrane from a position, in which said membrane is arranged adjacent to a first portion of a wall of the distribution duct to a position in which said membrane is arranged adjacent to a second portion of the wall of the distribution duct, which is opposite to the first portion, and vice versa.

Such air duct preferably comprises an interconnecting duct member, an outlet opening of which is connected to an inlet opening of the distribution duct, wherein the threaded rod with the transferrable holder and the element for delimiting the movement of the transferrable holder along a single plane are arranged within the interconnecting member and the regulation membrane has such a shape that, —when the transferrable holder is in any end position on the threaded rod—the regulation membrane is arranged adjacent to an internal wall of the interconnecting duct member in a region between the transferrable holder and the inlet opening of the distribution duct.

### DRAWINGS

The invention is further described using exemplifying embodiments and drawings, wherein FIG. 1 schematically illustrates a longitudinal cross-section of an air duct with an assembly according to an embodiment of the invention,

FIG. 2 shows an axial view into the assembly and the duct of FIG. 1,

FIG. 3 shows a similar view of a second embodiment,

FIG. 4 shows a similar view of a third embodiment,

FIG. 5 is a longitudinal view of the assembly and the duct of FIG. 4,

FIG. 6 shows a view into the assembly and the duct according to a fourth embodiment and

FIG. 7 shows a similar view into a fifth embodiment.

### DESCRIPTION OF EXEMPLIFYING EMBODIMENTS

The illustrated air duct comprises a feed duct 10, interconnecting duct member 5 and distribution duct 2. The distribution duct 2 has a circular cross-section and is made of a woven or a non-woven textile or a foil (possibly of a metal) and further it has a first portion 21, which surrounds the upper part of the cross-section of the distribution duct 2 and a second portion 22 which surrounds the lower part of the cross-section of the distribution duct 2, wherein the dividing plane between the first portion 21 and the second portion 22 extends in the duct's longitudinal direction, preferably in the duct's axis, and it is further called a tilt plane.

The first as well the second portion of the distribution duct 2 is provided with through openings for distribution of air into the surroundings of the distribution duct (not shown).

An impermeable regulation membrane 1 is attached inside the distribution duct 2, namely to mutually opposite sides of the distribution duct 2, always along the tilt plane, in other words along the line between the first portion 21 and the second portion 22 of the distribution duct 2.

FIG. 1 also shows a feed duct 10, which also has a circular cross-section and which is interconnected with the inlet end of the distribution duct 2 by means of an interconnecting duct member 5.

The interconnecting duct member 5 is provided with an assembly for positioning of the regulation membrane 1, that is to say for moving the end of the regulation membrane 1 up or down so that the membrane tilts towards the first portion 21 or towards the second portion 22 of the distribution duct, thus selectively covering/closing the through openings in the first portion 21 or in the second portion 22.

In the region between the inlet end and the outlet end of the interconnecting member 5, a frame is arranged within the interconnecting member 5, the frame being square shaped in this embodiment. The frame comprises a pair of mutually opposite side bars 71 and a pair of mutually opposite supporting bars 72, 73. In this embodiment, the side bars 71 provide the function of guide rails.

The length of the side of the square frame is preferably 1 to 1.2 times the diameter of the distribution duct 2.

Thus, in the present embodiment, a region of the interconnecting duct member 5, in which the frame is housed, has a square cross-section, which surrounds the frame.

A threaded rod 8 is rotationally attached to the frame, the rod extending in parallel to the side bars 71. In the illustrated embodiment, a lower bearing 74 is fixed to the lower supporting bar 72, wherein the lower end of the threaded rod 8 is arranged in said lower bearing 74, and an upper bearing 75 is fixed to the upper supporting bar 73, wherein the upper end of the threaded rod 8 is arranged in said upper bearing 75 and the upper end of the threaded rod 8 is connected to a motor 9 which drives the rotational movement of said threaded rod 8 about its longitudinal axis.

The bearings 74, 75 may be arranged within the interconnecting duct member 5 and the motor 9 can be arranged outside of the interconnecting duct member 5. Alternatively, the bearings 74, 75 may also be arranged outside of the interconnecting duct member 5 or both the motor 5 and the bearings 74, 75 may be arranged within the interconnecting duct member 5.

The pitch of the threaded rod 8 is 8 mm, generally preferably the pitch is 4 to 12 mm, more preferably 6 to 10 mm. Preferably, a trapezoidal thread is used.

The motor 9 is preferably an electric motor, most preferably a DC current motor.

The assembly according to the invention further comprises a carrier 84 provided with an internally threaded pass-through opening, the thread being complementary to the external thread of the threaded rod 8. The carrier 84 is screwed on the threaded rod 8 and a transfer bar 83 is fixed to it so that it extends in parallel to the supporting bars 72, 73.

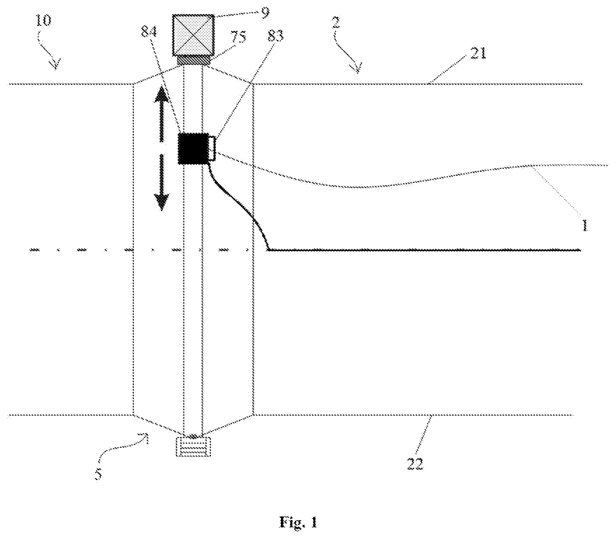

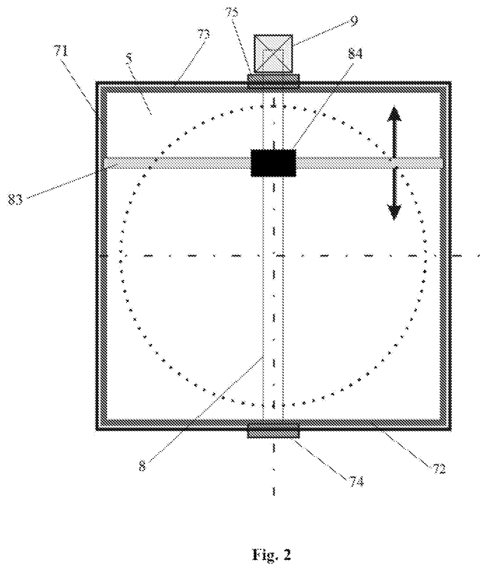

Thus, the carrier 84 and the transfer bar 83 together form a transferrable holder for holding and transferring the membrane 1. In an alternative embodiment (not shown), the transferrable holder of FIGS. 1 and 2 consists of the transfer bar 83 which is provided with a pass-through opening with an internal thread.

Ends of the transfer bar 83 are engaged with the side bars 71. The side bars 71 may have e.g. a U-shaped profile and may be facing each other with their open regions of the profile, wherein the ends of the transfer bar 83 extend into said U-profiles and are guided by them. Alternatively, the side bars 71 may have a rectangular or circular or other profile, wherein the ends of the transfer bar 83 may be each provided with a groove, into which a part of the side bar 71 fits. Generally, it is preferable to make the transfer bar 83 and the side bars 71 such that at least one end of the transfer bar 83 has a surface complementary to the side bar 71, thus allowing guiding of the sliding movement of the transfer bar 83 in the direction of the longitudinal axis of the side bar 71.

An end of the regulation membrane 1 is attached to the transfer bar 83, preferably along its entire length. The portion of the regulation membrane 1 extending into the interconnecting duct member 5 has a shape such that, in end positions of said membrane, it corresponds to the internal wall of the interconnecting duct member 5, that is to say that it is adjacent to said internal wall.

The length of the interconnecting member 5 from its inlet end to the outlet end is preferably in the range of 0.5 to 1.5, preferably 0.8 to 1.2 times the diameter of the distribution duct 2 or the length of the trajectory of the carrier 84 between its end positions on the threaded rod 8.

The assembly illustrated on FIGS. 1 and 2 operates as follows: In winter, when warm air is fed to the air duct, the regulation membrane 1 is tilted towards the first portion 21 of the distribution duct 2 such that it covers the through openings in the first part 21. The transfer bar 83 with the carrier 84 are arranged in the upper end position, as close as possible to the upper supporting bar 73 or rather such that they extend along the upper internal wall of the interconnecting duct member 5.

The air fed through the feed duct 10 flows through the interconnecting duct member 5 into the distribution duct 2 and through the through openings in the second portion 22 of the wall, so that the air flows downwards into a room to be heated. When it is required that the air shall start to flow upwards from the distribution duct, e.g. when the room is to be cooled by feeding cool air, the motor 9 is started, wherein said motor causes rotation of the threaded rod 8. The carrier 84 is firmly connected to the transfer bar 83 which is engaged with the side bars 71 and this engagement prevents a rotation of the transfer bar 83, thus also of the carrier 84, with respect to the frame along with rotation of the threaded rod 8. As a consequence of rotation of the threaded rod 8, the carrier 84 moves along the threaded rod 8 downwards to the lower end position, in which the carrier 84 and the transfer bar 83 extend along the lower internal wall of the interconnecting duct member 5.

When the desired end position of the carrier 84 is reached, the motor stops. The end of the regulation membrane 1 attached to the transfer bar 83 has been thus transferred downwards and the remaining portion of the regulation membrane 1 is also moved downwards by force of gravity and by the airflow, so that the membrane has thus covered and closed the openings in the lower portion 22 of the wall of the distribution duct 2.

The air fed by the feed duct 10 flows through the interconnecting duct member 5 into the distribution duct 2 and it flows through the through openings in the first portion 21 of the wall up to the ceiling of the room to be cooled.

When the motor 9 is started again, rotating in the other direction, the carrier 84, the transfer bar 83 and the regulation membrane 1 move upwards again.

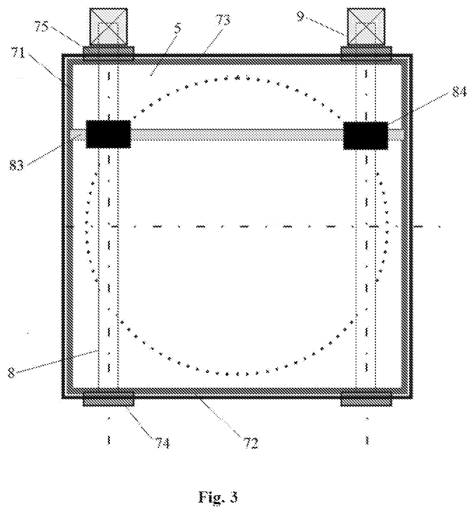

In an alternative embodiment illustrated in FIG. 3, two spaced apart parallel threaded rods 8 may be used, wherein a carrier 84 is arranged on each of them and the transfer bar 83 is fixed to said two carriers 84. In such a case, the side bars 71 do not have to be present because fixing of a transfer bar 83 to two carriers 84 prevents rotation of the transfer bar 83 about the longitudinal axis of any of the threaded rods 8.

In ducts having an especially large diameter, a multitude of threaded rods 8 may be used, the threaded rods 8 carrying a common transfer bar 83 on their carriers 84.

Even in this case, there may be used just the transfer bar 83 instead of the assembly of the carrier 84 and the transfer bar 83, wherein said transfer bar would be provided with a through opening with an internal thread for each of the threaded rods 8.

The threaded rods 8 are preferably arranged so that their axes extend in a common plane and have an identical pitch. The motors 9 are preferably mutually interconnected directly or via a common switch or via a common control unit (not shown) to make the movement of all of the carriers 84 always synchronized.

In the illustrated embodiment, the air duct is horizontally suspended. Nevertheless, the assembly according to the invention may be also used for air ducts in which the distribution duct is suspended in other way, e.g. vertically, that is to say with a vertical longitudinal axis and a vertical imaginary dividing plane between the first portion 21 and the second portion 22 of the wall of the distribution duct.

The motor 9 may be switched by means of a control unit, possibly by means of a remote control.

In yet another variant of the embodiment of FIGS. 1 and 2, the motor 9 can be replaced with a handle or other kind of manual controller, by means of which the threaded rod 8 may be rotated, thus moving the transferrable holder and tilting the regulation membrane 1 into a desired position.

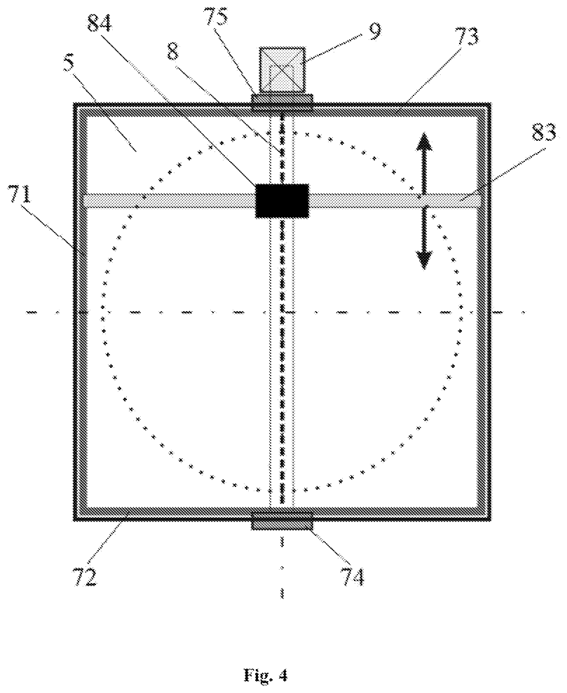

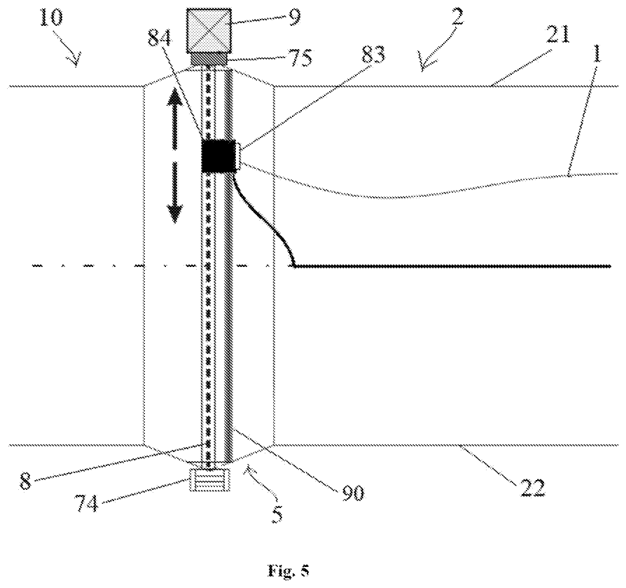

The embodiment of FIGS. 4 and 5 comprises a forward-positioned guide rod 90. The guide rod 90 is arranged spaced apart and in parallel with respect to the threaded rod 8 with a trapezoidal thread, wherein the threaded rod 8 is housed in the bearings 74, 75, similarly to the embodiment of FIG. 1. The guide rod 90 is fixed to the frame, that is to say with one end to the lower supporting bar 72 and with the other end to the upper supporting bar 73, wherein said rod has a circular cross-section. The carrier 84 is provided with two openings, one of which is provided with a thread complementary to the external thread of the threaded rod 8 and the diameter of the second opening corresponds to the diameter of the guide rod 90 with a suitable clearance. The carrier 84 is fixed to the transfer bar 83 similarly to preceding embodiments.

When the motor 9 is started, the threaded rod 8 begins to rotate and the transfer bar 83 with the carrier 84 begin to move upwards or downwards depending on the direction of rotation of the motor 9. The guiding of the carrier 84 by the guide rod 90 prevents the transfer bar 83 from rotating about the threaded rod 8, such that it ensures the movement of the transfer bar 83 along a single plane.

In an alternative embodiment, the guide bar 90 is replaced with a pair of guide rods 90, which pass through the pass-through openings in the carrier 84 or in the transfer bar 83, the axes of which being parallel to the axis of the threaded rod 8 and being arranged e.g. before and behind the threaded rod 8 or on sides of the threaded rod 8.

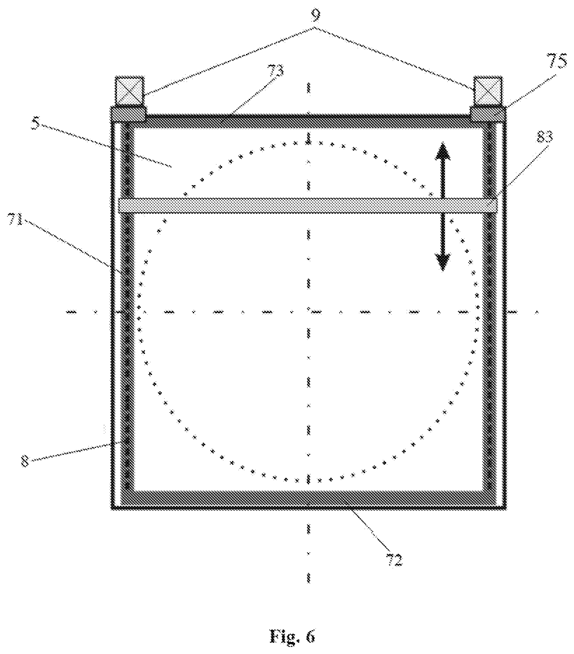

The embodiment shown in FIG. 6 comprises a pair of mutually opposite threaded rods 8 having a trapezoidal thread, wherein said threaded rods are arranged within the side bars 71, wherein said side bars may be e.g. in the form of U-profiles. In this embodiment, the transfer bar 83 is not provided with a carrier 84 but is itself provided at both of its ends with an opening having an internal thread, the thread being complementary to the trapezoidal thread of the corresponding threaded rod 8. The threaded rods 8 are fixed in the bearings 75 on their upper end and their lower ends are freely arranged or rotationally mounted in the lower supporting bar 72.

When the pair of motors 9 is started, the pair of threaded rods 8 begins to rotate, the rotation causing the transfer bar 83 to move upwards or downwards. As a consequence of using two threaded rods 8, the transfer bar 83 is prevented from rotating as such.

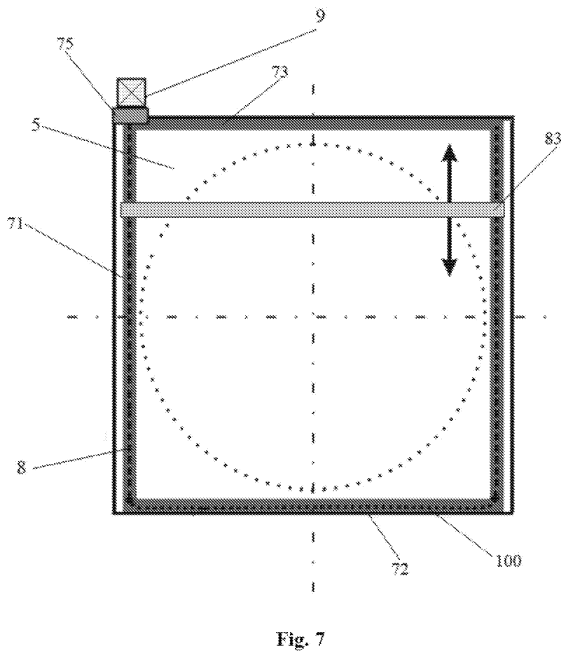

The embodiment of FIG. 7 also comprises a pair of threaded rods 8 which are arranged in side bars 71, opposite and in parallel to each other. One of the threaded rods 8 (any of them) is arranged in the bearing 75 with its one end and may be driven by the motor 9. The other threaded rod 8 is, with its upper end, rotationally arranged in the upper supporting bar 73. A flexible shaft 100 is arranged in the lower supporting bar 72 (e.g. in the form of a U-profile). The ends of this flexible shaft 100 are connected to the lower ends of the threaded rods 8 which ensures transmission of movement from one (driven) threaded rod 8 to the other. The flexible shaft 100 is thus arranged substantially in parallel to the supporting bars 72 and 73, but its ends are bent upwards. The transfer bar 83 is again provided with two threaded openings, wherein each of the threads is complementary to the respective thread of the respective threaded rod 8.

Thus, when the motor 9 is started, one of the threaded rods 8 begins to rotate and, by means of the flexible shaft 100, the other threaded rod 8 begins to rotate as well. As a consequence of using two threaded rods 8 for moving the common transfer bar 83, the transfer bar 83 is prevented from rotating during the rotation of the threaded rods 8.

In another embodiment, the pair of threaded rods 8 and the flexible shaft 100 may be replaced by a single flexible shaft having an external thread, that is to say by a single threaded rod 8 which is formed by a flexible shaft having an external thread.

Rods having other than trapezoidal thread may be used as well.

The drawings illustrate an embodiment with a circular cross-section of the distribution duct 2. Nevertheless, the invention may be also used for distribution ducts 2 having other types of cross-section, e.g. oval, rectangular etc.

The invention may be also used for closing supply of air into a room when one of the portions 21, 22 of the wall of the distribution duct 2 is not provided with openings for the passage of air. As an example, just the second portion 22 of the wall of the distribution duct 2 may be provided with openings so that after moving the regulation membrane 1 to the second portion 22 the openings are closed and no air flows from the distribution duct 2 into the room, in which the distribution duct 2 is arranged.

In yet another embodiment, the invention may be used for closing supply of air into a distribution duct 2, e.g. by means of an application for the regulation membrane, illustrated in WO2016141901 in FIG. 10.

The assembly is preferably arranged in the interconnecting member 5 but it may be also arranged in the distribution duct 2, if said duct is appropriately adjusted in terms of its shape.

In yet another (not shown embodiment), the transfer bar 83 is made up by two portions, wherein one portion extends between the carrier 84 and one side bar 71 and the other between the carrier 84 and the second (opposite) side bar 71.

For each of the above-mentioned and/or below-claimed embodiments it is suitable to provide those with at least one element for delimiting the movement of the carrier 84 or of the transfer bar 83 along a plane, which is parallel or identical to the plane, in which the longitudinal axis of the threaded rod 8 extends. Such an element may be:
At least one side bar 71 into which the holder of the membrane, e.g. the transfer bar 83 or a pin protruding from the carrier 84 extends, preferably two mutually opposite side bars 71, into each of which the transfer bar 83 or a pin protruding from the carrier 84 extends,
At least one rod fixed to the frame in parallel to the axis of the threaded rod 8, said rod passing through a through opening in the holder, e.g. in the carrier 84 or in the transfer bar 83,
A pair of rods or bars, fixed to the frame along the plane, along which the holder, e.g. the transfer bar 83 or the carrier 84 moves,
At least one other threaded rod 8, wherein the threaded rods 8 are arranged mutually parallel and a common holder, e.g. a common carrier 84 and/or a common transfer bar 83 is associated with them,
Any combination of the above-mentioned elements for delimiting the movement of the holder, i.e. of the carrier 84 and thus also of the transfer bar 83 along the longitudinal axis of the threaded rod 8 in a plane.

The threaded rod 8 can be also attached in various ways/to various parts of the assembly: The threaded rod 8 can be attached for example to:
The frame, which is (while the assembly is in operation) arranged within the (textile) duct,
A metal duct, in which the regulation membrane 1 is arranged,
A metal duct, which comprises a side opening with an attached branch air duct with a regulation membrane 1,
A supporting structure from which the duct is suspended,
A ventilator cover, to which an air duct comprising the regulation membrane 1 is attached, etc.

The above-described embodiments relate to ducts made of woven or non-woven fabric or foil, which is a washable material. However, it is also possible to use a combination of a regulation membrane made of impermeable textile or foil even for ducts, the circumferential walls of which are made of sheet metal or other rigid material.

It is clear that a person skilled in the art would readily find further possible alternatives to the embodiments described herein. The scope of the protection is therefore not limited to these exemplifying embodiments but it is rather defined by the appended patent claims.

1-14. (canceled)

15. An assembly for positioning of a regulation membrane in an air duct, said assembly comprising:
a threaded rod;
a transferrable holder adapted for attaching the regulation membrane thereto and having a through opening with an internal thread, said transferrable holder being screwed on the threaded rod and being movable along a longitudinal axis of the threaded rod by rotation of the threaded rod in the through opening of the transferrable holder; and
at least one element configured for delimiting movement of the transferrable holder along a single plane.

16. The assembly of claim 15, wherein the transferrable holder comprises a carrier and a transfer bar, wherein the through opening in which the transferrable holder is screwed on the threaded rod is arranged in the carrier, and wherein the transfer bar is fixed to the carrier.

17. The assembly of claim 15, further comprising a frame to which the threaded rod is rotationally attached.

18. The assembly of claim 17, wherein the frame comprises a pair of mutually opposite supporting bars.

19. The assembly of claim 18, wherein at least one of the supporting bars includes a bearing, wherein the threaded rod is rotationally attached to the supporting bars by the bearing.

20. The assembly of claim 16, further comprising a frame to which the threaded rod is rotationally attached, wherein the frame comprises a pair of mutually opposite and in parallel arranged side bars configured for guiding movement of the transfer bar in a plane along the longitudinal axis of the threaded rod and for preventing rotation of the transfer bar relative to the frame.

21. The assembly of claim 15, further comprising a guide bar arranged in parallel to the threaded rod, wherein the guide bar extends slidably through a hole in the transferrable holder.

22. The assembly of claim 15, further comprising a motor interconnected with the threaded rod, wherein the motor is configured for driving rotational movement about the longitudinal axis of the threaded rod.

23. The assembly of claim 15, wherein the threaded rod has a pitch of 4 to 12 millimeters.

24. The assembly of claim 15, further comprising a second threaded rod arranged in parallel to the first threaded rod, wherein the transferrable holder comprises a second through opening with an internal thread through which the second threaded rod passes.

25. An apparatus comprising an air duct member and an assembly for positioning of a regulation membrane in the air duct member, wherein the assembly is arranged at least partially within an interior of the air duct member, wherein the assembly comprises:
a threaded rod;
a transferrable holder adapted for attaching the regulation membrane thereto and having a through opening with an internal thread, said transferrable holder being screwed on the threaded rod and being movable along a longitudinal axis of the threaded rod by rotation of the threaded rod in the through opening of the transferrable holder, and
at least one element configured for delimiting movement of the transferrable holder along a single plane.

26. The apparatus of claim 25, wherein the threaded rod is arranged so that the longitudinal axis of the threaded rod is arranged in a plane perpendicular to a longitudinal axis of the air duct member.

27. An apparatus comprising:
an air duct comprising a distribution duct;
a regulation membrane arranged within the distribution duct; and
an assembly configured for positioning the regulation membrane in the distribution duct, wherein the assembly is arranged at least partially within an interior of the air duct, wherein the assembly comprises:
a threaded rod,
a transferrable holder adapted for attaching the regulation membrane thereto and having a through opening with an internal thread, said transferrable holder being screwed on the threaded rod and being movable along a longitudinal axis of the threaded rod by rotation of the threaded rod in the through opening of the transferrable holder, and
at least one element configured for delimiting movement of the transferrable holder along a single plane,
wherein one end of the regulation membrane is fixed to the transferrable holder,
wherein the transferrable holder is configured for moving the regulation membrane back and forth between
a position in which the regulation membrane is arranged adjacent to a first portion of a wall of the distribution duct and
a position in which the regulation membrane is arranged adjacent to a second portion of the wall of the distribution duct, wherein the second portion of the wall is opposite the first portion of the wall.

28. The apparatus of claim 27, wherein the air duct further comprises an interconnecting duct member, an outlet opening of which is connected to an inlet opening of the distribution duct, wherein the threaded rod with the transferrable holder and the element configured for delimiting the movement of the transferrable holder along a single plane are arranged within the interconnecting duct member, and wherein the regulation membrane has such a shape that, when the transferrable holder is in any end position on the threaded rod, the regulation membrane is arranged adjacent to an internal wall of the interconnecting duct member in a region between the transferrable holder and the inlet opening of the distribution duct.
